(19) United States
(12) Patent Application Publication
(10) Pub. No.: US 2010/0003459 A1
(43) Pub. Date: Jan. 7, 2010

(54) Optical laminated film

(75) Inventors: Kazuya Ohishi, Shizuoka (JP); Chikara Murata, Shizuoka (JP); Hideki Moriuchi, Shizuoka (JP); Masaomi Kuwabara, Shizuoka (JP)

Correspondence Address: JORDAN AND HAMBURG LLP, 122 EAST 42ND STREET, SUITE 4000, NEW YORK, NY, 10168, US

(73) Assignee: TOMOEGAWA Co., Ltd., Chuo-ku, TOKYO (JP)

(21) Appl. No.: 12/449,269

(22) PCT Filed: Jan. 31, 2008
(86) PCT No.: PCT/JP2008/051488

§ 371 Date: Jul. 30, 2009

(30) Foreign Application Priority Data
Jan. 31, 2007 (JP) 2007-022448

(51) Int. Cl. B32B 5/16

(52) U.S. Cl. 428/147

(57) ABSTRACT

An optical layered film includes a transparent substrate on which a radiation curing resin layer containing translucent resin fine particles is layered, which has an internal haze value (X) and a total haze value (Y) satisfying Y>X, Y≦X+11, Y≦50 and X≧15, and has fine irregularity shapes on the outermost surface of the resin layer.

### BACKGROUND OF THE INVENTION

The present invention relates to optical layered films to be provided on display surfaces of liquid crystal displays (LCDs), plasma displays (PDPs) and the like and, in particular, to optical layered films for improving visibility of screens.

In recent years, displays such as LCDs and PDPs have been developed to be produced and sold in various sizes for a number of applications ranging from mobile phones to large-size televisions.

Such displays may have impaired visibility of images due to room lightings such as fluorescent lights, sunlight incident through windows, glares of shadows of an operator and so on onto the display surfaces. As such, in order to improve visibility, the display surfaces are provided with functional films on the outermost surface, such as anti-glare films having fine irregularity structures, which are capable of diffusing surface-reflected lights, suppressing regular reflectance of external lights and preventing glares of outside environments (having anti-glare properties) (conventional AG).

These functional films are generally produced and sold as products comprising a transparent substrate such as polyethylene terephthalate (hereinafter referred to as “PET”) and triacetyl cellulose (hereinafter referred to “TAC”) on which a single anti-glare layer having fine irregularity structures is provided or as products comprising a light-diffusing layer on which a low refractive index layer is layered; with development now being carried out for functional films providing desired functions through combinations of layer configurations.

With a recent progress of an increase in size, definition and contrast of displays, however, there is now a need for enhancement of performance required for such functional films.

When an anti-glare film is used for the outermost surface, images in black tend to be whitish due to light diffusion with a disadvantageous decrease in contrast for use in a bright room. An anti-glare film is therefore needed which attains a high contrast even at the sacrifice of decreased anti-glare property (high-contrast AG).

In order to attain a high contrast, a method has been adopted in which the top layer of an anti-glare film is provided with one or more low reflection layers (AG with low reflection layer).

On the other hand, when an anti-glare film is used on the outermost surface, a problem arises in which scintillation (portions with different brightnesses) appears on the surface supposedly due to fine irregularity structures, decreasing visibility. Such scintillation is likely to occur in association with an increased definition in association with an increase in the number of pixels for a display and with improvement of display techniques such as pixel division system. An anti-glare film having scintillation prevention effects is therefore desired (high-resolution AG).

In order to attain scintillation prevention effects, development is ongoing for a method as in Patent Reference 1, in which mean spacing of profile irregularities (Sm), center line average surface roughness (Ra) and ten-point average surface roughness (Rz) of the surface of functional films are specifically defined and for a method for regulating glare of external lights into a screen, scintillation phenomenon and white blurring balance as in Patent References 2 and 3, in which areas of surface haze and internal haze are defined in detail. As such, in designing a light-diffusing sheet to be used for high resolution LCDs, interior diffusion property for providing scintillation prevention effects and surface diffusion property for providing prevention effect of white blurring are controlled.

Patent Reference 1: Japanese Unexamined Patent Publication No. 2002-196117

Patent Reference 2: Japanese Unexamined Patent Publication No. 1999-305010

Patent Reference 3: Japanese Unexamined Patent Publication No. 2002-267818

### SUMMARY OF THE INVENTION

Thus, there are problems to be solved such as anti-glare function, high contrast and scintillation prevention and they are in a tradeoff relationship in which one of the properties can be sought only at the sacrifice of the others. Nothing so far has satisfied these functions with a configuration comprising a transparent substrate on which a single layer is layered. As such, as a method for providing these functions simultaneously, development is under way with respect to the shape of membranes and film surfaces to be layered in a multi-layer manner. Such multi-layering however requires a process for coating a transparent substrate with multiple layers, incurring more cost. Also, it is difficult to adjust the balance between the multiple layers, only allowing in fact to select and implement part of these functions according to the intended use.

It is therefore a primary object of the present invention to provide an optical layered film applicable to high-resolution LCDs which has functions of antiglare, high contrast and scintillation prevention in a balanced manner and, in particular, to provide an optical layered film in which these functions are achieved in a configuration comprising a transparent substrate on which a single layer is layered.

As a result of keen studying, the present inventor has found that, through building fine structures on the surface of an optical layered film and also varying internal and total haze values, a range exists within which all the functions of antiglare, high contrast and scintillation prevention, which have so far been considered in a tradeoff relationship, may be optimized, to successfully accomplish the present invention.

The present invention (1) is an optical layered film comprising a transparent substrate on which a radiation curing resin layer containing translucent resin fine particles is layered, which has an internal haze value (X) and a total haze value (Y) satisfying the formulae (1) to (4):

Y>X (1)

Y≦X+11 (2)

Y≦50 (3) and

X≧15 (4),

and has fine irregularity shapes on the outermost surface of the resin layer.

The present invention (2) is the optical layered film according to the invention (1) wherein the fine irregularity shapes have an average slope angle of 0.4° to 1.6°.

The present invention (3) is the optical layered film according to the invention (1) or (2) wherein the fine irregularity shapes have a mean spacing of profile irregularities (Sm) of 50 to 200 μm.

The present invention (4) is the optical layered film according to any one of the inventions (1) to (3) wherein the outermost surface of the resin layer has a Macbeth reflective density of 2.0 or higher.

The present invention (5) is the optical layered film according to any one of the inventions (1) to (4) wherein a low reflection layer is provided over the resin layer.

The optical layered film according to the present invention has anti-glare property, high contrast and scintillation prevention in an excellently balanced manner despite that it comprises a transparent substrate on which a single layer is layered, and enables highly visible, quality image displaying when it is used for a display surface. The optical layered film also enables a reduction in cost as it reduces the number of coating steps.

### DETAILED DESCRIPTION OF THE INVENTION

First, each component of the optical layered film according to the best mode (transparent substrate and radiation curing resin layer) will be described in detail. To begin with, transparent substrates according to the best mode are not particularly limited as long as they are translucent. Glasses such as quartz glass and soda glass may be used. However, various resin films of PET, TAC, polyethylene naphthalate (PEN), polymethyl methacrylate (PMMA), polycarbonate (PC), polyimide (PI), polyethylene (PE), polypropylene (PP), polyvinyl alcohol (PVA), polyvinyl chloride (PVC), cycloolefin copolymers (COC), norbornene-containing resins, polyether sulfone, cellophane, aromatic polyamides and the like may preferably be used. For use in PDPs and LCDS, films of PET and TAC are more preferred.

The transparency of these transparent substrates is preferably as high as possible. The total light transmittance (JIS K7105) of such substrates is preferably 80% or higher and more preferably 90% or higher. Also, the thickness of the transparent substrates is preferably small in view of weight saving. In consideration of productivity and ease of handling, however, those having a thickness in the range of 1 to 700 μm and preferably in the range of 25 to 250 μm are preferably used.

Also, the adhesion property between the transparent substrate and the resin layer can be enhanced by subjecting the transparent substrate to surface treatment such as alkali treatment, corona treatment, plasma treatment and sputtering and/or surface modification treatment such as coating of surfactants, silane coupling agents or the like or Si vapor deposition.

Next, the radiation curing resin layer according to the best mode will be described in detail. Radiation curing resin layers according to the best mode are not particularly limited as long as they are formed by radiation-curing radiation curable resin compositions and, in addition, contain translucent resin fine particles. Here, examples of radiation curable resin compositions for comprising the resin layers include monomers, oligomers and prepolymers having radically polymerizable groups such as acryloyl, methacryloyl, acryloyloxy and methacryloyloxy groups or cationically polymerizable groups such as epoxy, vinyl ether and oxetane groups. These can be used alone or in combination as appropriate. Examples of monomers may include methyl acrylate, methyl methacrylate, methoxy polyethylene methacrylate, cyclohexyl methacrylate, phenoxyethyl methacrylate, ethylene glycol dimethacrylate, dipentaerythritol hexaacrylate, trimethylolpropane trimethacrylate and pentaerythritol triacrylate. Examples of oligomers and prepolymers may include acrylate compounds such as polyester acrylates, polyurethane acrylates, multifunctional urethane acrylates, epoxy acrylates, polyether acrylates, alkyd acrylates, melamine acrylates and silicone acrylates, unsaturated polyesters, epoxy-based compounds such as tetramethylene glycol diglycidyl ether, propylene glycol diglycidyl ether, neopentyl glycol diglycidyl ether, bisphenol-A diglycidyl ether and various cycloaliphatic epoxies as well as oxetane compounds such as 3-ethyl-3-hydroxymethyl oxetane, 1,4-bis-{[(3-ethyl-3-oxetanyl)methoxy]methyl}benzene and di[1-ethyl-(3-oxetanyl)]methyl ether. These can be used alone or in combination of two or more.

The radiation curable resin compositions described above can be cured as such by irradiation with electron rays. When they are cured by irradiation with ultraviolet rays, however, addition of photopolymerization initiators will be needed. Radiations to be used may be ultraviolet rays, visible lights, infrared rays or electron rays. Also, these radiations may be polarization or non-polarization. Examples of photopolymerization initiators include radical polymerization initiators, such as acetophenones, benzophenones, thioxanthones, benzoin and benzoin methyl ether as well as cationic polymerization initiators, such as aromatic diazonium salts, aromatic sulfonium salts, aromatic iodonium salts and metallocene compounds. Such photopolymerization initiators can be used alone or in combination as appropriate.

According to the best mode, in addition to the radiation curable resin compositions described above, polymer resins may be added to such an extent that the polymerization curing may not be prevented. Such polymer resins are thermoplastic resins soluble in organic solvents to be used for coating materials for resin layers to be subsequently referred to, specific examples of which include acrylic resins, alkyd resins and polyester resins. Such resins preferably contain acidic functional groups such as carboxyl, phosphoric and sulfonic groups.

Also, additives such as leveling agents, viscous agents and anti-static agents may be used. Leveling agents work to equalize the surface tension of coating layers to repair any defects before formation of coating layers. Substances lower in both boundary tension and surface tension than the radiation curable resin compositions described above are used as leveling agents. Viscous agents work to impart thixotropy to the radiation curable resin compositions described above and are effective in formation of fine irregularity shapes on the surface of resin layers due to the prevention of translucent resin fine particles, pigments and the like from sedimentation.

The resin layer is mainly comprised of a cured product of the radiation curable resin compositions mentioned above. A process for forming it comprises applying a coating material comprising a radiation curable resin composition and an organic solvent and volatilizing the organic solvent, before irradiating with an electron ray or ultraviolet ray to effect curing. Organic solvents to be used here must be selected among those preferred for dissolving the radiation curable resin composition. Specifically, organic solvents selected from alcohols, esters, ketones, ethers and aromatic hydrocarbons may be used alone or in combination, in consideration of coatabilities such as wettability toward transparent substrates, viscosity and drying rate.

The thickness of the resin layer is preferably in the range of 1.0 to 12.0 μm, more preferably in the range of 2.0 to 11.0 μm and even more preferably in the range of 3.0 to 10.0 μm. When the hardcoat layer is smaller than 1 μm in thickness, insufficient curing may occur due to oxygen inhibition during ultraviolet ray curing to deteriorate abrasion resistance of the resin layer, and when the hardcoat layer is larger than 12 μm in thickness, curing shrinkage of the resin layer may cause curls, micro cracks, a decrease in adhesion property in relation to the transparent substrate or a decrease in light transmission. It may also cause a cost increase due to an increase in coating material needed in association with the increase in thickness.

As translucent resin fine particles to be contained in the radiation curing resin layer, organic translucent resin fine particles comprised of acrylic resins, polystyrene resins, styrene-acrylics copolymers, polyethylene resins, epoxy resins, silicone resins, polyvinylidene fluoride, polyethylene fluoride and the like may be used. The refractive index of the translucent resin fine particles is preferably from 1.40 to 1.75. When the refractive index is smaller than 1.40 or larger than 1.75, a difference in refractive index in relation to the transparent substrate or the resin layer will be too great, lowering the total light transmittance. Also, the difference in refractive index between the translucent resin fine particles and the resin is preferably 0.2 or smaller. The average particle size of the translucent resin fine particles is preferably in the range of 0.3 to 10 μm and more preferably in the range of 1 to 5 μm. Particle sizes smaller than 0.3 μm are not preferred, because anti-glare property will deteriorate, while particle sizes larger than 10 μm are not preferred either, because scintillation will occur and the degree of surface irregularity will be so great that the surface may turn whitish. Also, proportions of the translucent resin fine particles to be contained in the resin described above are not particularly limited. It is, however, preferred that the proportions are from 1 to 20 parts by weight in relation to 100 parts by weight of the resin composition for satisfying characteristics such as anti-glare function and scintillation and for easily controlling haze values and fine irregularity shapes of the surface of the resin layer.

According to the present invention, it is preferred to provide a low reflection layer over the radiation curing resin layer in order to enhance contrast. In such a case, the refractive index of the low reflection layer must be lower than that of the radiation curing resin layer and is preferably 1.45 or smaller. Materials having such characteristics include inorganic low reflection materials comprised of fine particulated inorganic materials such as LiF (refractive index n=1.4), MgF₂ (n=1.4), 3NaF.AlF₃ (n=1.4), AlF₃ (n=1.4) and Na₃AlF₆ (n=1.33) that are included in an acrylic resin, epoxy resin and the like as well as organic low reflection materials such as fluorine-based and silicone-based organic compounds, thermoplastic resins, thermosetting resins and radiation curing resins. Among them, fluorine-containing materials are preferred for prevention of stains. Also, the low reflection layer preferably has an interfacial tension of 20 dyne/cm or lower. When the interfacial tension is higher than 20 dyne/cm, stains once adhered to the low reflection layer will be difficult to remove.

Examples of the fluorine-containing materials described above include vinylidene fluoride-based copolymers, fluoroolefin/hydrocarbon copolymers, fluorine-containing epoxy resins, fluorine-containing epoxy acrylates, fluorine-containing silicones and fluorine-containing alkoxysilanes, which are soluble in organic solvents and easy to handle. These can be used alone or in combination of two or more.

Also, radiation curable, fluorine-containing monomers, oligomers and prepolymers and so on, such as fluorine-containing methacrylates, such as 2-(perfluorodecyl)ethyl methacrylate, 2-(perfluoro-7-methyloctyl)ethyl methacrylate, 3-(perfluoro-7-methyloctyl)-2-hydroxypropyl methacrylate, 2-(perfluoro-9-methyldecyl)ethyl methacrylate and 3-(perfluoro-8-methyldecyl)-2-hydroxypropyl methacrylate, fluorine-containing acrylates, such as 3-perfluorooctyl-2-hydroxypropyl acrylate, 2-(perfluorodecyl)ethyl acrylate and 2-(perfluoro-9-methydecyl)ethyl acrylate, epoxides, such as 3-perfluorodecyl-1,2-epoxypropane and 3-(perfluoro-9-methyldecyl)-1,2-epoxypropane, epoxy acrylates may be mentioned. These can be used alone or in combination of two or more.

Further, a low reflection material comprised of a sol made of ultrafine silica particles with a size of 5 to 30 nm that are dispersed in water or an organic solvent in mixture with a fluorine-based film former may be used. Used as the sol made of ultrafine silica particles with a size of 5 to 30 nm that are dispersed in water or an organic solvent are known silica sols obtained by condensing an activated silicate such as by a process for dealkalizing alkaline metal ions in an alkaline silicate through ion exchange or the like and/or by a process for neutralizing an alkaline silicate with a mineral acid, known silica sols obtained by hydrolyzing and condensing an alkoxysilane in an organic solvent under the presence of a basic catalyst and organic solvent-based silica sols (organosilica sols) obtained by substituting water in the aqueous silica sols described above with an organic solvent by distillation and the like. These silica sols can be used both in aqueous and organic solvent systems. For producing organic solvent-based silica sols, it is unnecessary to completely substitute water with an organic solvent. The silica sols described above contain 0.5 to 50% by weight of solid content as SiO₂. The ultrafine silica particles in the silica sols may be spherical, needle-shaped, plate-shaped and the like.

As film formers, alkoxysilanes, metal alkoxides, hydrolysates of metal salts, fluorine-modified polysiloxanes and the like may be used. Among the film formers as described above, fluorine-containing compounds may preferably be used in particular because they can suppress adhesion of oils due to a decrease in interfacial tension of the low reflection layer. The low reflection layer according to the present invention may be obtained by diluting the materials mentioned above with a diluent for example and applying it to a radiation curing resin layer by means of a spin coater, roll coater, printing and the like, followed by drying and setting it by heat or radiation (when an ultraviolet ray is used, the photopolymerization initiators described above are used) and the like. Although radiation curable, fluorine-containing monomers, oligomers and prepolymers are excellent in antifouling properties, they are poor in wettability and thus cause problems that the low reflection layer is repelled on the radiation curing resin layer depending on the composition and that the low reflection layer is delaminated from the radiation curing resin layer. It is therefore desirable to appropriately mix and use the monomers, oligomers and prepolymers having polymerizable unsaturated bonds, such as acryloyl series, methacryloyl series, acryloyloxy group and methacryloyl group, described as the radiation curing resins mentioned above to be used for the radiation curing resin layers.

When plastics-based films that are likely to be damaged by heat, such as PET and TAC, are used for transparent substrates, radiation curing resins are preferably selected for the materials of these low reflection layers.

Thicknesses for low reflection layers to provide good anti-reflection functions can be calculated according to known equations. When an incident light enters a low reflection layer orthogonally, the following relationships must only be satisfied as conditions for the low reflection layer not to reflect the light but to allow the light to be transmitted at 100%. In the equations, Nₒ represents the refractive index of the low reflection layer, Nₛ represents the refractive index of the radiation curing resin layer, h represents the thickness of the low reflection layer and λₒ represents the wavelength of the light.

[Equation 1]

Nₒ=Nₛ^{1/2} (1) and

Nₒh=λₒ/4 (2)

It is appreciated that, according to the equation (1) above, in order to prevent the reflection of light at 100%, a material must be selected such that the refractive index of the low reflection layer may be the square root of the refractive index of the underlying layer (the radiation curing resin layer). It is however difficult to find a material which fully satisfies this equation and therefore a material which is as close as possible to such a material is to be selected. According to the equation (2) above, the optimum thickness as an anti-reflection film for the low reflection layer is calculated based on the refractive index of the low reflection layer selected according to the equation (1) and on the wavelength of the light. For example, assuming that the refractive indices of the radiation curing resin layer and the low reflection layer are 1.50 and 1.38 respectively and the wavelength of the light is 550 nm (reference of spectral luminous efficacy), by substituting these values into the equation (2) above, the optimum thickness of the low reflection layer will be calculated as approximately 0.1 μm and preferably in the range of 0.1±0.01 μm.

Next, properties of the optical layered film according to the best mode will be described in detail. Other function-imparting layers may be provided underlying the radiation curing resin layer. Specifically, an anti-static layer, a near infrared (NIR) absorption layer, a neon shielding layer, an electromagnetic wave shielding layer and a hardcoat layer may be provided. The optical layered film has an internal haze value (X) and a total haze value (Y) which satisfy the formulae (1) to (4) below. Here, a “total haze value” refers to a haze value of an optical layered film and an “internal haze value” refers to a value obtained by subtracting a haze value of a transparent sheet with pressure-sensitive adhesive from a haze value of an optical layered film having the transparent sheet over the surface of fine irregularity shapes of the optical layered film. Both the haze values refer to those measured according to JIS K7015.

Y>X (1)

Y≦X+11 (2)

Y≦50 (3) and

X≧15 (4)

Here, within the range of Y>X+11, the surface turns whitish, decreasing contrast, because light diffusion effects over the surface increase. A preferred range is X+1<Y<X+8 and a more preferred range is X+2≦Y≦X+6. Within the ranges of Y≦X+11 and Y>50, transmittance decreases while displayed white images are observably colored, degrading visibility. Within the range of X<15, interior diffusion effects are insufficient so that scintillation may appear. A preferred range is 18<X<40 and a more preferred range is 25≦X≦35.

Further, the optical layered film has fine irregularity shapes on the outermost surface of the resin layer described above. Here, the fine irregularity shapes have an average slope angle, as calculated from average slopes given according to ASME 95, in the range of 0.4 to 1.6, more preferably in the range of 0.5 to 1.4 and even more preferably in the range of 0.6 to 1.2. With an average slope angle below 0.4, anti-glare property will deteriorate, while with an average slope angle above 1.6, contrast will deteriorate, making the optical layered film unsuitable to be used for display surfaces. Further, the fine irregularity shapes have a mean spacing of profile irregularities (Sm) in the range of 50 to 250 μm, more preferably in the range of 55 to 220 μm and even more preferably in the range of 60 to 180 μm. Further, the fine irregularity shapes have a Macbeth reflective density of 2.0 or higher, more preferably 2.5 or higher and even more preferably 2.7 or higher.

Further, the optical layered film has a definition of a transmitted image preferably in the range of 5.0 to 70.0 (a value measured according to JIS K7105, using a 0.5 mm optical comb) and more preferably in the range of 20.0 to 65.0. With a definition of a transmitted image below 5.0, contrast will deteriorate, while with a definition above 70.0, anti-glare property will deteriorate, making the optical layered film unsuitable to be used for display surfaces.

Next, a process for producing the optical layered film according to the best mode will be described in detail. First, a method for controlling various parameters as characteristics of the present invention, such as surface irregularity shapes and haze values, will be described in detail. First, for controlling the range of X (internal haze) or bringing X within the range of X≧15, adjustment may be made by a difference in refractive index between the translucent fine particles and the radiation curable resin and loading of the translucent fine particles (content per unit area). Also, in order to bring it within the range of Y≦X+11, the loading of the translucent fine particles (content per unit area) and irregularities by the translucent fine particles need to be adjusted through coating layer thickness, physical properties of coating material, drying conditions and the like. In particular, use of a viscous agent as a material can suppress sedimentation of fillers and facilitate position adjustment of the fillers along the thickness direction, enabling desired characteristics to be obtained. Here, as a method for controlling the X described above (internal haze) and controlling to bring it within the range of Y≦X+11, a method may be adopted in which two kinds of translucent fine particles are used. Here, the control described above may be made more easily than when using a single kind of translucent fine particles. In such a case, translucent fine particles whose refractive index is the same as that of the radiation curing resin and translucent fine particles whose refractive index is different from that of the radiation curing resin may be used in combination.

For other respects, procedures similar to those for conventional optical layered films are applicable. For example, processes for forming a resin layer on a transparent substrate are not particularly limited. For example, a transparent substrate is applied with a coating material containing a radiation curable resin composition including translucent fine particles and the coating material is dried, followed by curing to produce a resin layer having fine irregularity shapes on the surface. As procedures for applying a coating material to a transparent substrate, any ordinary coating or printing methods are applicable. Specifically, coating, such as airdoctor coating, bar coating, blade coating, knife coating, reverse-roll coating, transfer roll coating, gravure roll coating, kiss coating, cast coating, spray coating, slot orifice coating, calendar coating, dam coating, dip coating and die coating as well as intaglio printing, such as gravure printing and stencil printing, such as screen printing may be used.

### EXAMPLES

Example of the present invention and comparative examples will be illustrated below. “Parts” are intended to mean “parts by weight.”

A coating material for resin layer was obtained by dispersing a mixture comprising components for coating material listed below for 30 minutes in a sandmill and was coated by reverse-roll coating method on one side of TAC as a transparent substrate having a thickness of 80 μm and a total light transmittance of 92%. After drying at 100° C. for one minute, ultraviolet irradiation was carried out in a nitrogen atmosphere using one 120 W/cm, beam-condensing, high-pressure mercury vapor lamp (irradiation distance 10 cm, irradiation time 30 seconds) to cure the coated film.

### Components of Coating Material for Resin Layer

Pentaerythritol triacrylate (trade name: PE3A, solid content 100% solution, refractive index 1.52, Kyoeisha Chemical Co., Ltd.) 28.44 parts

Polyfunctional urethane acrylate (trade name: BEAMSET 575BT, solid content 100% solution, refractive index 1.52, Arakawa Chemical Industries, Ltd.) 12.19 parts

Photopolymerization initiator (trade name: Irgacure-184, Ciba Specialty Chemicals Inc.) 2.14 parts

Leveling agent (trade name: MEGAFACE F471, Dainippon Ink and Chemicals, Incorporated) 0.23 part

Crosslinked polystyrene beads (trade name: SX 350H, refractive index 1.60, particle size 3.5 μm, Soken Chemical & Engineering Co., Ltd.) 1.89 parts

Crosslinked acrylic beads (trade name: MX 500, refractive index 1.49, particle size 5 μm, Soken Chemical & Engineering Co., Ltd.) 1.17 parts

Viscous agent (trade name: Lucentite SAN, Co-op Chemical Co., Ltd.) 0.94 part

Toluene 53 parts

Thus, an optical layered film of Example having a resin layer 8 μm in thickness was obtained.

### Comparative Example 1

Components of coating material for resin were the same as those in Example 1 and the coating thickness on TAC was varied.

Thus, an optical layered film of Comparative Example 1 having a resin layer 4.4 μm in thickness was obtained.

### Comparative Example 2

Except that components of coating material for resin layer were replaced by those listed below, the same procedure as in Example was followed.

Epoxy acrylate-based UV resin (trade name KR-566, solid content 95% solution, refractive index 1.52, Asahi Denka Kogyo KK) 45 parts

Crosslinked acrylic beads (trade name: MX 150, refractive index 1.49, particle size 1.5 μm, Soken Chemical & Engineering Co., Ltd.) 0.75 part

Crosslinked acrylic beads (trade name: MX 220, refractive index 1.49, particle size 2.2 μm, Soken Chemical & Engineering Co., Ltd.) 0.75 part

Crosslinked acrylic beads (trade name: MX 300, refractive index 1.49, particle size 3.0 μm, Soken Chemical & Engineering Co., Ltd.) 0.75 part

Methyl isobutyl ketone 33 parts

Toluene 22 parts

Thus, an optical layered film of Comparative Example 1 having a resin layer 2.7 μm in thickness was obtained.

Using the optical layered films obtained in Example and Comparative Examples 1 and 2, haze values, total light transmittance, definition of a transmitted image, average slope angles, Ra, Sm, Macbeth reflective densities, anti-glare property, contrast and scintillation were measured and evaluated according to the procedures described below.

Haze values were measured according to JIS K7105, using a hazemeter (trade name: NDH 2000, Nippon Denshoku Industries Co., Ltd.).

Transparent sheets with pressure-sensitive adhesive used for measuring internal haze were as follows.

### Transparent Sheet

Component: polyethylene terephthalate (PET)

Thickness: 38 μm

### Pressure-Sensitive Adhesive Layer

Component: acrylic pressure-sensitive adhesive

Thickness: 10 μm

Haze of Transparent Sheets with Pressure-Sensitive Adhesive

3.42

Total light transmittance was measured according to JIS K7105, using the hazemeter described above.

Definition of a transmitted image was measured according to JIS K7105, using an image clarity meter (trade name: ICM-1DP, Suga Test Instruments Co., Ltd.) set to the transmission mode with an optical comb width of 0.5 mm.

Average slope angles were measured according to ASME 95, using a surface roughness measuring instrument (trade name: Surfcorder SE 1700α, Kosaka Laboratory Ltd.) by measuring average slopes and calculating average slope angles according to the equation:

Average slope angle=tan⁻¹ (average slope)

Ra and Sm were measured according to JIS B0601-1994, using the surface roughness measuring instrument described above.

Macbeth reflective densities were measured according to JIS K7654, using a Macbeth reflective densitometer (trade name: RD-914, Sakata Eng. Co., Ltd.) after blacking out with a Magic Ink® the optical layered films of Example and Comparative Examples on the sides opposite to the resin layers of the transparent substrates, to determine Macbeth reflective densities on the resin layer surfaces.

To evaluate anti-glare property, the optical layered films of Example and Comparative Examples were attached to the screen surface of a liquid crystal TV (trade name: Aquos LG-32GD4, Sharp Corporation) via adhesive layers. Thereafter, putting the liquid crystal display device out and viewing 50 cm apart perpendicularly from the center of the screen surface with an illuminance of 250 lx, one hundred volunteers visually determined the presence or absence of glares of their own images (faces) into the screen. Evaluations were rated as ∘, Δ and x when the number of people who did not perceive glares was 70 or more, from 30 to less than 70 and less than 30, respectively.

To evaluate contrast, the optical layered films of Example and Comparative Examples as well as nonglare films for comparison (trade name: SUN Filter NF, Suncrest Co., Ltd.) were attached to the screen surface of a liquid crystal TV (trade name: Aquos LG-32GD4, Sharp Corporation) via adhesive layers. Thereafter, putting the liquid crystal display device out and viewing 50 cm apart perpendicularly from the center of the screen surface with an illuminance of 250 lx, one hundred volunteers visually determined the blackness. Evaluations were rated as ∘, Δ and x when the number of people who perceived that the screen attached with the optical layered films was blacker than the screen attached with the nonglare film for comparison was 70 or more, from 30 to less than 70 and less than 30, respectively.

To evaluate scintillation, the optical layered films of Example and Comparative Examples were attached to the screen surface of a liquid crystal monitor (trade name: LL-T1620-B, Sharp Corporation) via adhesive layers. Thereafter, rendering the liquid crystal display device green in color and viewing 50 cm apart perpendicularly from the center of the screen surface with an illuminance of 250 lx, one hundred volunteers visually determined the presence or absence of scintillation. Evaluations were rated as ∘, Δ and x when the number of people who did not perceive scintillation was 70 or more, from 30 to less than 70 and less than 30, respectively.

The results of evaluations according to the procedures described above are shown in Table 1.

TABLE 1

| | tot. | int. | tot. | | slope | | | Mac. | anti | | |
|---|---|---|---|---|---|---|---|---|---|---|---|
| | haze | haze | trans. | def. | angle | Ra | Sm | dens. | glare | cont. | scin. |
| Ex. | 27.70 | 23.33 | 93.50 | 59.7 | 0.80 | 0.103 | 154 | 3.26 | ∘ | ∘ | ∘ |
| Com. Ex. 1 | 33.22 | 12.17 | 92.01 | 1.0 | 2.87 | 0.462 | 119 | 2.41 | ∘ | x | x |
| Com. Ex. 2 | 5.07 | 0.84 | 92.19 | 20.8 | 1.43 | 0.181 | 117 | 2.86 | ∘ | ∘ | x |

tot. haze: total haze value
int. haze: internal haze value
tot. trans.: toral light transmittance
def.: definition of a transmitted image
Mac. dens.: Macbeth reflective densities
cont.: contrast
scin.: scintillation

The optical layered film of Example 1 satisfied anti-glare property, contrast and scintillation in a balanced manner, while the optical layered film of Comparative Example 1 with Y>X+11 failed to satisfy contrast and the optical layered film of Comparative Example 2X<15 failed to satisfy scintillation.

### INDUSTRIAL APPLICABILITY

As described above, optical layered films satisfying anti-glare property, contrast, color reproducibility and scintillation in a balanced manner may be provided by controlling haze values, definition of a transmitted image and average slope angles within appropriate ranges.

1. An optical layered film comprising a transparent substrate on which a radiation curing resin layer containing translucent resin fine particles is layered, which has an internal haze value (X) and a total haze value (Y) satisfying the formulae (1) to (4):
Y>X (1)
Y≦X+11 (2)
Y≦50 (3) and
X≧15 (4),
and has fine irregularity shapes on the outermost surface of the resin layer.

2. The optical layered film according to claim 1, wherein the fine irregularity shapes have an average slope angle of 0.4° to 1.6°.

3. The optical layered film according to claim 1, wherein the fine irregularity shapes have a mean spacing of profile irregularities (Sm) of 50 to 200 μm.

4. The optical layered film according to claim 1, wherein the outermost surface of the resin layer has a Macbeth reflective density of 2.0 or higher.

5. The optical layered film according to claim 1, wherein a low reflection layer is provided over the resin layer.
